(19) United States
(12) Patent Application Publication
(10) Pub. No.: US 2024/0413323 A1
(43) Pub. Date: Dec. 12, 2024

(54) Cathode Active Material for Lithium-Ion Battery and Method for Preparing Said Active Material, and Cathode Comprising Said Active Material and Method for Preparing Said Cathode

(71) Applicant: Vidyasirimedhi Institute of Science and Technology (VISTEC), Rayong (TH)

(72) Inventors: Montree Sawangphruk, Bangkok (TH); Panyawee Bunyanidhi, Bangkok (TH); Farkfun Duriyasart, Nonthaburi (TH); Poramane Chlochan, Bangkok (TH); Nutthaphon Phattharasupakun, Nonthaburi (TH); Chanikam Tomon, Bangkok (TH); Sangchai Sarawutanukul, Bangkok (TH); Salatan Duangdangchote, Nonthaburi (TH); Worapol Tejangkura, Bangkok (TH); Chonticha Jangsan, Maha Sarakham (TH)

(21) Appl. No.: 18/696,799

(22) PCT Filed: Dec. 3, 2021
(86) PCT No.: PCT/IB2021/061270

§ 371 Date: Mar. 28, 2024

(30) Foreign Application Priority Data
Sep. 28, 2021 (TH) 2101006016

(51) Int. Cl. H01M 4/525; H01M 4/02; H01M 4/04; H01M 4/36; H01M 4/505; H01M 4/62; H01M 10/0525

(52) U.S. Cl. CPC H01M 4/525; H01M 4/0416; H01M 4/366; H01M 4/505; H01M 4/623; H01M 4/625; H01M 10/0525; H01M 2004/021; H01M 2004/028

(57) ABSTRACT

The present invention relates to a cathode active material for a lithium-ion battery having a structure comprising a core and a shell, wherein the core comprises lithium nickel manganese cobalt oxide compound, and the shell is lithium lanthanum zirconate (LLZO) with a mass ratio of core to shell in a range of 90-99 to 1-10. Furthermore, the present invention relates to a method for preparing said active material and to the cathode of the battery comprising the said active material and a method for preparing the said cathode. The invention also relates to a battery comprising said cathode. The lithium-ion battery having the cathode comprising the active material according to the present invention has an improved charge-discharge efficiency and good stability.

### TECHNICAL FIELD

Chemical technology related to a cathode active material for lithium-ion battery and a method for preparing said active material, and a cathode comprising said active material and a method for preparing said cathode

### BACKGROUND OF THE INVENTION

Battery-related studies have received vast attention due to the higher market demand for the development of high-energy battery, especially the development of battery for electric vehicle and hybrid electric vehicle, valve-regulated lead-acid battery, and nickel-metal hydride battery. However, there remains a need to continuously develop other kinds of battery in order to obtain higher energy battery.

Lithium-ion battery is considered an energy source with a potency in applications, high capacity and capacity per weight, as well as a longer life cycle compared to other types of battery. This type of battery is not only an energy storage for portable digital electronic products and electric vehicle or hybrid vehicle, but it also has a sufficiently high potency to be used in the solar wind-derived alternative energy storage system. Accordingly, the market demand for the lithium-ion battery increases considerably and grows rapidly for applications in different fields. Cathode presently plays an important role in the development and application of the lithium-ion battery in that, besides serving as a lithium ion (Li⁺) storage in the system, the material used to produce such electrode is also a main factor that affects the battery capacity and its production cost. Therefore, the development of materials for making the cathode which has been improved in various aspects, such as safety, cost-effective production, and high efficiency and capacity, would promote a more effective application of the lithium-ion battery.

Transition metal oxide attracts great attention for its use as a material for making the cathode of the lithium-ion battery because of its high capacity of approximately 250 mAh/g, lower price, and safety that is higher than lithium cobalt oxide (LiCoO₂:LCO). Transition metal oxide, particularly lithium nickel cobalt aluminium oxide (LiNiₓCo_{y}Al_{z}O₂:NCA) material and lithium nickel manganese cobalt oxide (LiNiₓMn_{y}Co₂O₂:NMC) material, shows high capacity due to key components like lithium manganese oxide (Li₂MnO₃), which can provide the main structure layer with an excess lithium and plays a significant role in rendering the structure of such material sufficiently stable against the entering and leaving of lithium ion in the structure during the application of battery. However, these materials may cause an irreversible capacity (IRC), depending on the composition of each material. For example, when lithium nickel manganese cobalt oxide material is exposed to an electrolyte solution for a long time or when the cycle of application is increased, the materials will react with the electrolyte solution, causing the original structure R(-)3m to transform into the rock salt structure Fm(-)3m which is a stable structure. Therefore, it is difficult for a reversible reaction to occur, resulting in the loss of energy storage ability.

Additionally, the lithium nickel manganese cobalt oxide material still has a major problem of cation mixing where the ions of lithium and nickel are mixed on crystal area of 3D interconnected network of NMC. This phenomenon is known to reduce the electrochemical efficiency of an oxide material with a layered structure as the ionic radius of Li⁺ is close to that of Ni²⁺, resulting in an ion exchange between lithium ion and nickel ion at the nearest position to neutralize the combined charges and reduce the Coulomb energy. The mixing of cations in the structure will obstruct the diffusion of lithium and cause the loss of lithium storage capacity.

Improvement of the cathode material surface is one of the approaches which can improve the electrochemical efficiency of the cathode material. It was reported that metal oxides or phosphate compound of various metals are suitable as a surface coating material, such as Al₂O₃, MgO, TiO₂, MnO₂, and ZrO₂. Using these materials to improve the cathode material surface will increase the structure stability and battery efficiency and reduce the loss of irreversible capacity. The improved cathode material will then have a core-shell structure with an energy storage material as a core and other materials as an encapsulating material to reduce contact between the energy storage material and the electrolyte solution.

Examples of patent documents and academic documents concerning the development of cathode material having the core-shell structure are as follows.

U.S. Pat. No. 10,439,212 B2 discloses a coating of an energy storage material Li_{1.2}Mn_{0.53}Ni_{0.13}Co_{0.12}O₂ with aluminium borate (AlBO₃) and aluminium phosphate (AlPO₄) using a precipitation method. It can be seen from this US patent that by coating the energy storage material surface with aluminium borate, the irreversible capacity can be reduced and the stability and capacity retention can be increased, as compared to the NMC material with uncoated surface. However, aluminium borate and aluminium phosphate are low conductive materials; it is therefore a disadvantage in that the battery capacity cannot be increased.

U.S. Pat. No. 9,543,581 B2 discloses an NMC energy storage material coated with aluminium oxide (Al₂O₃) using a dry coating method. Nevertheless, it was found that upon increasing the number of moles of aluminium oxide coated on the NMC material, the capacity decreased in accordance with the mol % of aluminium, and it was found that the battery capacity decreased in accordance with the increased mol % of aluminium. Moreover, the aluminium oxide-coated NMC material has less capacity as compared to the capacity of NMC material with uncoated surface due to an increase in the battery's internal resistance, while the capacity retentions are similar when increasing the mol % of aluminium.

Academic document titled “Atomic Layer Deposition of Solid-state Electrolyte Coated Cathode Materials with Superior High-voltage Cycling Behavior for Lithium-ion Battery Application” published in 2014 in the Energy & Environmental Science journal, volume 7, pages 768-778, discloses a button battery using the NMC cathode material as an energy storage material with the ratio of Ni to Mn to Co of 1/3 to 1/3 to 1/3. The NMC energy storage material is coated with lithium tantalate (LiTaO₃), which is a solid-state electrolyte, using an atomic layer deposition method. It was found that upon increasing the coating thickness, the difference between the anode peak and the cathode peak becomes greater, meaning more polarization in the system due to the low conductivity of lithium tantalate. However, after adjusting the coating thickness of lithium tantalate, it was found that the battery's capacity and capacity retention increased, as compared to normal NMC material, but the disadvantage is that coating the surface with a non-conductive material will increase the battery's internal resistance.

Academic document titled “Mechanism Study on the Interfacial Stability of a Lithium Garnet-Type Oxide Electrolyte against Cathode Materials” published in 2018 in the ACS Applied Energy Materials journal, volume 11, pages 5968-5976, discloses a button battery using the cathode materials LiCoO₂ (LCO) and Li(NiCoMn)_{1/3}O₂ (NCM) coated with a solid electrolyte which is tantalum-doped lithium lanthanum zirconate (Ta-doped Li₇La₃Zr₂O₁₂) using a ball mill together with co-sintering. It was found that coating the NMC energy storage material with tantalum-doped lithium lanthanum zirconate after sintering can increase the battery's capacity.

With respect to the aforementioned patents and academic documents, the stability development and the cycle life extension of a battery by encapsulating the energy storage material with different metal oxide materials still have limitations as those metal oxide materials used for encapsulation have low conductivity or high resistance; the capacity is therefore reduced or not as high as it should be.

### SUMMARY OF THE INVENTION

In the first aspect, the present invention relates to a cathode active material for a lithium-ion battery having a structure comprising a core and a shell, wherein the core comprises lithium nickel manganese cobalt oxide compound, and the shell is lithium lanthanum zirconate (LLZO) with a mass ratio of core to shell in a range of 90-99 to 1-10.

In the second aspect, the present invention relates to a method for preparing a cathode active material for a lithium-ion battery having a structure comprising a core and a shell, the method comprising the steps of:
(a) providing the core comprising lithium nickel manganese cobalt oxide compound having a shape and size as required,
(b) providing the shell which is lithium lanthanum zirconate, and
(c) coating the shell obtained from step (b) onto a surface of the core obtained from step (a) with a mass ratio of core to shell in a range of 90-99 to 1-10.

In the third aspect, the present invention relates to a cathode for a lithium-ion battery comprising the active material according to the present invention, a binder, and a conductive material.

In the fourth aspect, the present invention relates to a method for preparing a cathode for a lithium-ion battery comprising the steps of preparing a mixture of the cathode active material according to the present invention, the binder, and the conductive material, and coating the obtained mixture onto a substrate.

In the fifth aspect, the present invention relates to the lithium-ion battery comprising the cathode having the active material according to the present invention.

The present invention is aimed at developing the cathode active material for the lithium-ion battery with high lithium-ion conductivity to aid the lithium-ion exchange between the active material and the electrolyte solution and to avoid a reaction between the active material and the electrolyte solution.

The lithium-ion battery having the cathode comprising the active material according to the present invention has an improved charge-discharge efficiency. It can also extend the battery life by increasing the stability and cycle number of the battery.

### BRIEF DESCRIPTION OF THE DRAWINGS

FIG. 1 is images obtained from a scanning electron microscope (SEM) showing the characteristic of the surface of the exemplary cathode active materials, wherein (1a) shows the surface of the comparative active material at 2,500× magnification, (1b) shows the surface of the comparative active material at 5,000× magnification, (1c) shows the surface of the exemplary active material according to the present invention at 2,500× magnification, and (1d) shows the surface of the exemplary active material according to the present invention at 5,000× magnification.

FIG. 2 is images obtained from the scanning electron microscope showing the characteristic of the surface of the exemplary cathode active material according to the present invention at 5,000× magnification, wherein (2a) and (2b) show the surface of the exemplary active materials according to the present invention with the mass ratio of core to shell of 95:5 and 90:10, respectively.

FIG. 3 is images obtained from the scanning electron microscope together with an analysis of elements and composition using the EDX (Energy Dispersive X-ray analysis) technique which shows the analysis of elements of the exemplary cathode active materials according to the present invention at different mass ratios of core to shell, wherein
(3a) shows the characteristic of the exemplary active material with the mass ratio of core to shell of 99:1,
(3b) shows the analysis of nickel in the exemplary active material according to (3a),
(3c) shows the analysis of lanthanum in the exemplary active material according to (3a),
(3d) shows the characteristic of the exemplary active material with the mass ratio of core to shell of 95:5,
(3e) shows the analysis of nickel in the exemplary active material according to (3d),
(3f) shows the analysis of lanthanum in the exemplary active material according to (3d),
(3g) shows the characteristic of exemplary active material with the mass ratio of core to shell of 90:10,
(3h) shows the analysis of nickel in the exemplary active material according to (3g), and
(3i) shows the analysis of lanthanum of the exemplary active material according to (3g).

FIG. 4 is images obtained from a transmission electron microscope (TEM) together with an analysis of elements and composition using the EDX technique which shows the characteristic and the analysis of elements of the exemplary cathode active material according to the present invention with the mass ratio of core to shell of 99:1, wherein (4a) shows the characteristic of the exemplary active material and (4b) shows an analysis of nickel and lanthanum in the exemplary active material.

FIG. 5 is a graph obtained from an X-ray diffraction (XRD) analyzer showing the structures of the exemplary cathode active material according to the present invention and the comparative active material.

FIG. 6 is a graph showing the charge-discharge profile of a button battery comprising the cathode according to the present invention, which contains the active material at different ratios of lithium lanthanum zirconate shell, and a comparative button battery.

FIG. 7 is a graph showing the capacity retention at different cycle numbers of the button battery comprising the cathode according to the present invention, which contains the active material at different ratios of lithium lanthanum zirconate shell.

FIG. 8 is a graph showing the rate capability of button batteries comprising the cathode according to the present invention and the comparative example cycled from 3.0 to 4.3 V at high current density.

FIG. 9 is a graph showing the charge-discharge profiles of a cylindrical battery comprising the cathode according to the present invention and a comparative cylindrical battery.

FIG. 10 is graphs showing the capacity retention and charge-discharge efficiency (coulombic efficiency) at different cycle numbers of the cylindrical battery comprising the cathode according to the present invention (10a) and the comparative battery (10b).

FIG. 11 is a graph showing the capacity retention at different cycle numbers of the cylindrical battery comprising the cathode according to the present invention and the comparative battery.

### DETAILED DESCRIPTION

Any aspects shown herein shall encompass the application to other aspects of the present invention as well, unless specified otherwise.

Any tools, devices, methods, materials, or chemicals mentioned herein, unless specified otherwise, mean the tools, devices, methods, materials, or chemicals generally used or practiced by a person skilled in the art, unless explicitly specified as special or exclusive tools, devices, methods, materials, or chemicals for the present invention.

The terms “comprise(s),” “consist(s) of,” “contain(s),” and “include(s)” are open-end verbs. For example, any method which “comprises,” “consists of,” “contains” or “includes” one component or multiple components or one step or multiple steps is not limited to only one component or one step or multiple steps or multiple components as specified, but also encompass components or steps that are not specified.

According to the present invention, the term “mechanofusion process” in a broad sense means the use of strong mechanical energy to trigger a chemical reaction and a mechanism between material particles to design and improve such material to give it a new property and higher quality.

According to the first aspect, the present invention is aimed at developing the cathode active material for the lithium-ion battery having the structure comprising the core and the shell, wherein the core comprises lithium nickel manganese cobalt oxide compound and the shell is lithium lanthanum zirconate (LLZO) with the mass ratio of core to shell in a range of 90-99 to 1-10.

Preferably, lithium nickel manganese cobalt oxide compound has the formula Li(NiₐMn_{b}Co_{c})O₂, whereby 0<a<1, 0<b<1, 0<c<1 and the sum of a, b and c is 1. More preferably, lithium nickel manganese cobalt oxide compound has the formula Li(Ni_{0.8}Mn_{0.1}Co_{0.1})O₂.

Suitable lithium lanthanum zirconate according to the present invention should have a particle size in a range of 5-15 μm.

According to the present invention, the shell should have a thickness in a range of 0.1-1,000 μm.

The inventor of the present invention chose lithium lanthanum zirconate, which is an oxide compound containing a large amount of lithium in its structure, as a shell material for coating the core surface in order to develop the shell with high lithium-ion conductivity to aid the lithium-ion exchange between the active material and the electrolyte solution. Lithium lanthanum zirconate can also prevent a reaction between the electrolyte solution and the active material as it has low sensitivity and high lithium-ion conductivity which can increase the battery capacity. It can also enhance the compatibility of seam between the active material and the electrolyte solution, thus enabling an effective lithium-ion exchange between the active material and the electrolyte solution.

The second aspect of the present invention relates to the method for preparing the cathode active material for the lithium-ion battery having the structure comprising the core and the shell according to the first aspect of the present invention, the method comprising the steps of:
(a) providing the core comprising lithium nickel manganese cobalt oxide compound having a shape and size as required,
(b) providing the shell which is lithium lanthanum zirconate, and
(c) coating the shell obtained from step (b) onto the surface of the core obtained from step (a) with the mass ratio of core to shell in a range of 90-99 to 1-10.

Suitable lithium nickel manganese cobalt oxide compound for the preparation of the cathode active material according to the present invention is as described above, i.e. lithium nickel manganese cobalt oxide compound having the formula Li(NiₐMn_{b}Co_{c})O₂, whereby 0<a<1, 0<b<1, 0<c<1 and the sum of a, b and c is 1, more preferably with the ratio of nickel (Ni):manganese (Mn):cobalt (Co) of 8:1:1, i.e. having the formula Li(Ni_{0.8}Mn_{0.1}Co_{0.1})O₂ (NMC 811).

Likewise, suitable lithium lanthanum zirconate for the preparation of the cathode active material according to the present invention is as described above, i.e., lithium lanthanum zirconate having a particle size in a range of 5-15 μm with the shell thickness in a range of 0.1-1,000 μm.

According to a preferred embodiment of the invention, step (c) is carried out using the mechanofusion process with a speed ranging from 2,500-5,000 rpm, motor power ranging from 0.5-1.5 kW, temperature ranging from 20-50° C., and period of time ranging from 10-60 minutes.

The method for preparing the cathode active material according to the present invention may further comprise step (d) of modifying the surface of the core formed to obtain a smooth surface prior to performing step (c).

Preferably, step (d) is carried out using the mechanofusion process with a speed ranging from 1,500-3,500 rpm, motor power ranging from 0.2-1.2 kW, temperature ranging from 20-50° C., and period of time ranging from 10-30 minutes.

The third aspect of the invention relates to the cathode for the lithium-ion battery comprising:
the cathode active material according to the present invention having the structure and components as described above,
the binder, and
the conductive material.

For example, the binder can be selected from polyvinylidene fluoride (PVDF), poly(3,4-ethylenedioxythiophene) (PEDOT), polytetrafluoroethylene (PTFE), and a mixture thereof. The conductive material can be selected from carbon black, acetylene black, super P, and a mixture thereof.

Preferably, the weight ratio of active material to binder to conductive material is in a range of 90-98 to 1-5 to 1-5.

The fourth aspect of the invention relates to the method for preparing the cathode for the lithium-ion battery comprising the steps of:
preparing the mixture of the cathode active material according to the present invention, the binder, and the conductive material, and
coating the obtained mixture onto the substrate.

The binder and conductive material for preparing the mixture of the cathode active material can be selected from the list given above and the substrate is preferably aluminium.

Preferably, the weight ratio of cathode active material to binder to conductive material is in a range of 90-98 to 1-5 to 1-5.

Preferably, the preparation of the mixture of cathode active material, binder, and conductive material is performed by a stirring using N-methylpyrrolidone solution as a solvent, wherein the obtained mixture of cathode active material, binder, and conductive material has a viscosity in a range of 4,000-10,000 Pa·s.

According to a preferred embodiment of the present invention, the mixture of cathode active material, binder, and conductive material is coated onto the substrate with a coating thickness ranging from 200-270 μm.

The substrate coated with the mixture of cathode active material, binder, and conductive material may be dried, for example, by heating at a temperature ranging from 100-180° C.

The cathode comprising the obtained active material according to the present invention is particularly preferred for the production of different types of lithium-ion battery, e.g., cylindrical battery and button battery.

The present invention will now be described in more detail with reference to the example of the invention and the test result which will be discussed hereinafter with reference to the accompanying drawings but is not intended to limit the scope of the invention in any way.

### Example

### 1. Preparation of the Cathode Active Material

A process for preparing the exemplary cathode active material according to the present invention started with preparing the shell which is lithium lanthanum zirconate (LLZO) with the mass ratio of LLZO ranging from 1-10. LLZO was subjected to a ball mill to reduce the particle size to be in a range of 1-5 μm. The lithium nickel manganese cobalt oxide compound of formula Li(Ni_{0.8}Mn_{0.1}Co_{0.1})O₂ (NMC 811) used as the core material was subjected to a surface modification to obtain a spherical material with a smooth surface using the mechanofusion process to prepare for the coating of the shell mixture onto the spherical material surface. The process for preparing the surface of such spherical core material was performed using a mechanofusion device from Hosokawa Micron Corporation with a speed ranging from 1,500-3,500 rpm, motor power ranging from 0.2-1.2 kW, and controlled temperature ranging from 20-50° C. The process was carried out for a period of 10-30 minutes.

LLZO, which is the shell, was then coated onto the NMC 811 surface, which is the core, using the mechanofusion process with a speed ranging from 2,500-5,000 rpm, motor power ranging from 0.5-1.5 kW, and controlled temperature ranging from 20-50° C. The process was carried out for a period of 10-60 minutes.

### 2. Preparation of the Cathode

The preparation of the cathode was performed by mixing 90-150 g polyvinylidene fluoride (PVDF) serving as a binder with 500-1,500 g N-methylpyrrolidone solution and stirring for 10-60 minutes under vacuum. Then, 90-150 g carbon material was added and stirred for 10-60 minutes under vacuum. Then, 1,500-2,500 g cathode active material obtained from step 1 above was added, followed by the addition of 500-1,500 g N-methylpyrrolidone solution, and stirred until homogeneous using an automatic mixer for a period of 6-24 hours. N-methylpyrrolidone solution was added again to obtain a mixture with a viscosity ranging from 4,000-10,000 Pa·s. Such mixture was coated onto an aluminium sheet used as a substrate using an automatic coater with the coating thickness of 200-270 μm and a drying temperature of 100-180° C.

### 3. Preparation of the Anode

The preparation of the anode was performed by mixing 30-50 g carboxymethylcellulose serving as a binder and 50-100 g ethanol in 500-1,000 g deionized water using an automatic mixer and stirring using a large paddle at a speed of 50-100 rpm and a small paddle at 2,000-5,000 rpm for 1-2 hours under vacuum. Then, 20-50 g carbon material serving as a conductive material was added to the solution and stirred for another 20-60 minutes under vacuum. Then, 50-100 g ethanol was added to the solution and stirred for another 30-60 minutes under vacuum. Then, 1,500-2,000 g graphite material was added and stirred for another 1-2 hours under vacuum. Then, 50-100 g styrene-butadiene rubber serving as another binder and 500-1,000 g deionized water were added and stirred for one more hour under vacuum. Then, 500-1,000 g additional deionized water was added and stirred under vacuum until the mixture was combined. Then, the mixture was coated onto a copper sheet used as a substrate using an automatic coater with a coating thickness of 50-150 μm and a drying temperature of 100-130° C.

### 4. Battery Assembly

The cathode and the anode obtained from steps 2 and 3 were assembled into an 18650 cylindrical battery. The assembly started with calendering the cathode and the anode using an automatic calendaring machine with a pressure of 2-10 tons to obtain the thickness of the cathode and the anode of 100-160 and 50-160 μm, respectively. Then, the cathode and the anode were cut into 5.5-6.0 cm in width and 55-70 cm in length using an automatic cutter. Then, the head portion of the cathode was welded with an aluminium strip using a welding machine and the end portion of the anode was welded with a nickel strip using a welding machine as well. The electrodes were then wound together with a ceramic film between the two electrodes to prevent a short circuit using an automatic winding machine. The wound electrodes were then loaded into an 18650 cylindrical battery case. The case containing the electrodes was then subjected to a case grooving process. Then, a battery cap was welded to the electrodes inside the battery case before filling with 4-6 g electrolyte per one battery in an atmosphere-controlled chamber with the humidity and oxygen level lower than 0.1 ppm. The electrolyte solution used was lithium hexafluorophosphate which was dissolved in a solution mixed with ethyl carbonate, dimethyl carbonate, and ethyl methyl carbonate. The battery was then charged using an automatic battery charger before wrapping the battery with a polyvinyl chloride (PVC) sheet at a temperature of 120-160° C. in a belt oven to obtain an exemplary 18650 cylindrical battery prepared from the cathode comprising the active material according to the present invention.

### Test Result

The exemplary 18650 cylindrical battery comprising the cathode having the active material according to the present invention prepared according to steps 1-4 above was tested for its efficiency using an electrochemical technique by comparing it to the comparative battery, which is a conventional NMC 811 battery (NMC-Pristine). The test result is explained in conjunction with the accompanying drawings as follows.

### Study on the Characteristic of the Cathode Active Material

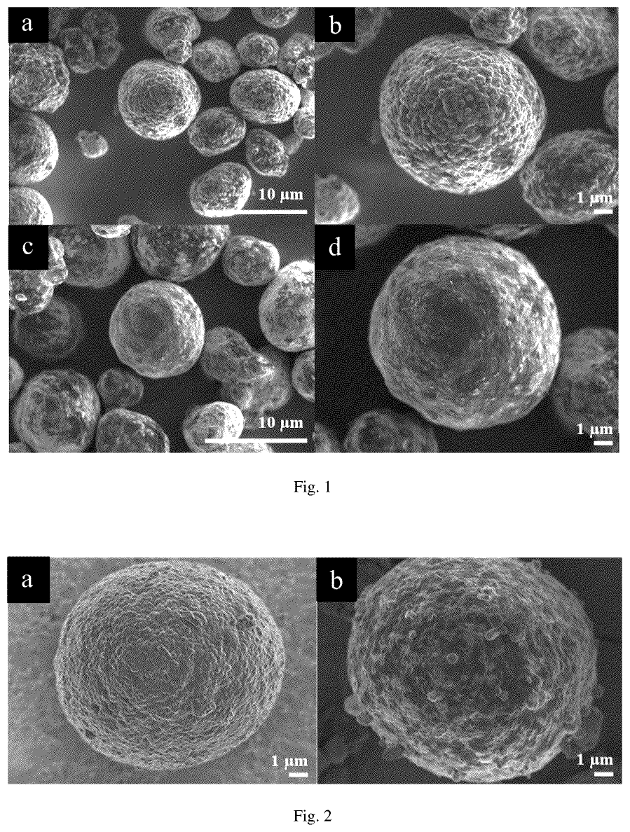

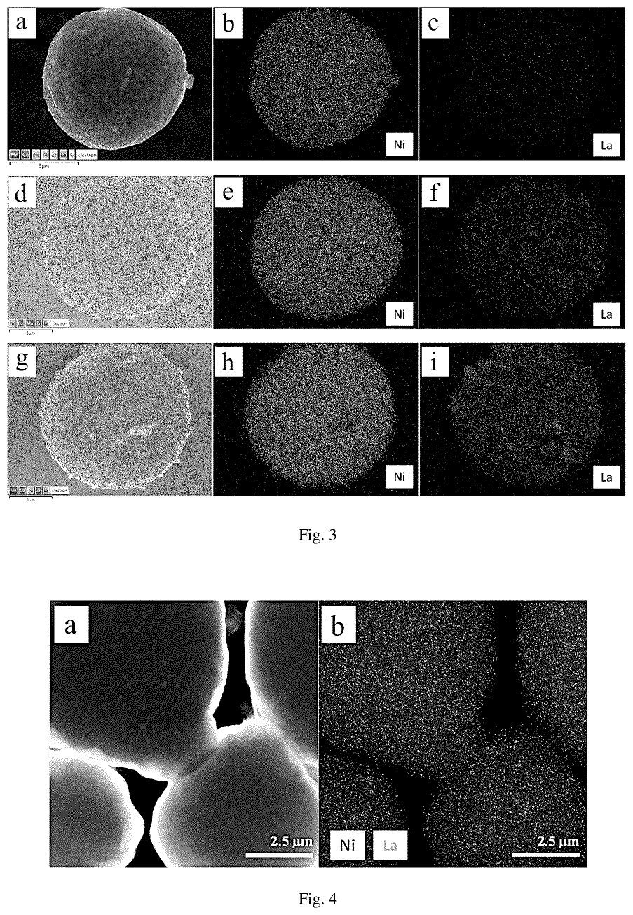

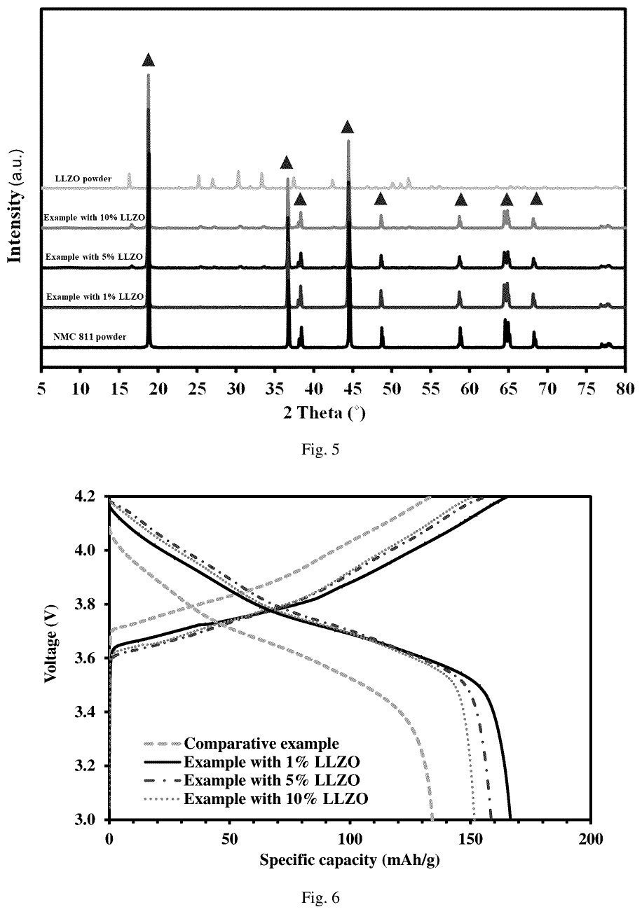

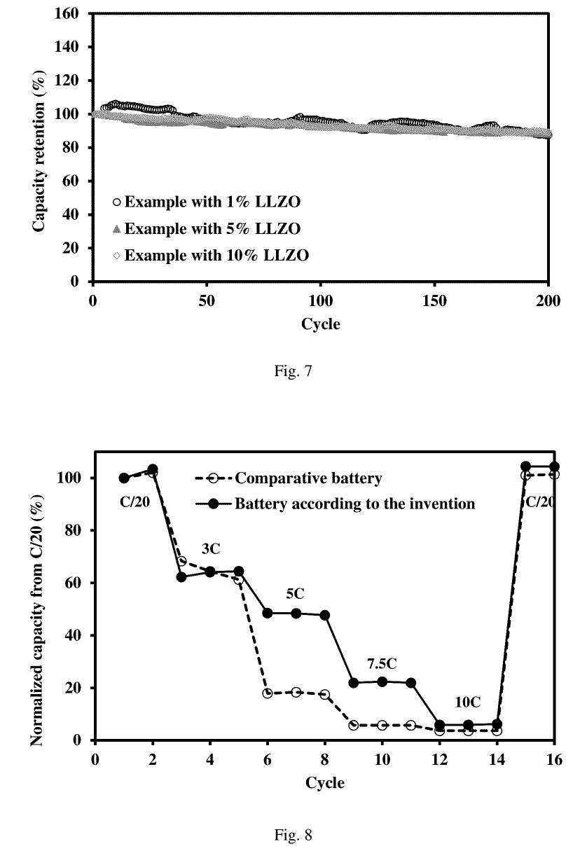

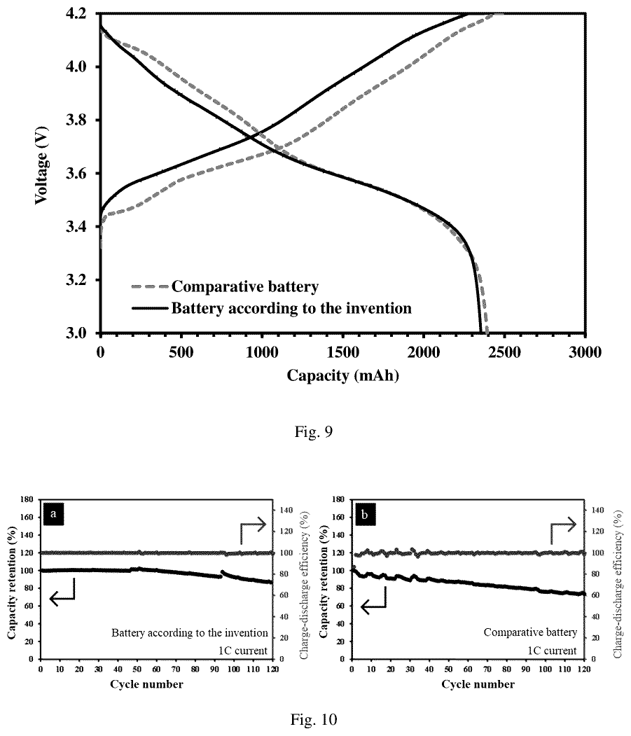

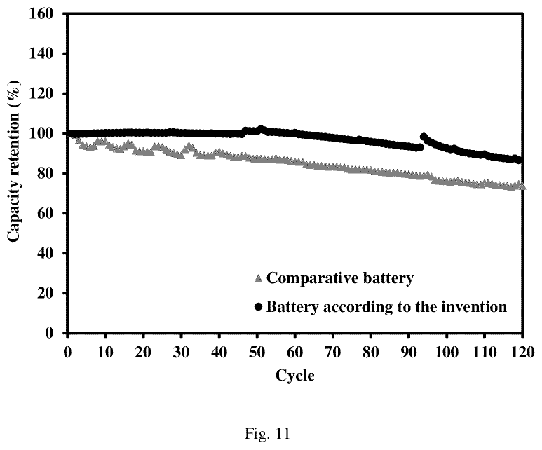

FIG. 1 is images obtained from the scanning electron microscope (SEM) showing the characteristic of the surface of the exemplary cathode active material. FIGS. (1a) and (1b) show the surface of the exemplary cathode active material of the comparative example at 2,500× and 5,000× magnification, respectively. FIGS. (1c) and (1d) show the surface of the cathode active material according to the present invention at 2,500× and 5,000× magnification, respectively. FIG. 2 shows the surface of the exemplary cathode active material according to the present invention at 5,000× magnification upon increasing the ratio of the shell which is lithium lanthanum zirconate (LLZO).

According to FIGS. (1a) and (1b), it can be seen that the surface of the cathode active material of the comparative example (NMC-Pristine) is spherical which is a secondary particle with a particle size of approximately 5-15 μm. Such spherical surface was composed by the agglomeration of small primary particles with a particle size of approximately 500 nm.

According to FIGS. (1c) and (1d), it can be seen that the surface of the cathode active material according to the present invention is spherical and slightly rough and has a particle size ranging from 5-15 μm. Upon observing the surface of the active material, it is impossible to clearly see the primary particles of the lithium nickel manganese cobalt oxide compound (NMC 811). However, small flakes were found on the material surface which are LLZO crystals. FIGS. (2a) and (2b) show that the surface of the cathode active material according to the present invention became rougher upon increasing the ratio of LLZO. The particles of metal oxide compound which are solid electrolyte were also found adhering external to the active material in some regions. The active material surface which was coated in such manner can reduce the penetration of a liquid electrolyte into the active material particles, which could provide negative effects to the battery's stability and cycle life.

Analysis of Elements which are the Composition of the Cathode Active Material

FIG. 3 is images obtained from the scanning electron microscope (SEM) together with the analysis of elements and composition using the EDX technique showing the analysis of elements of the exemplary cathode active material according to the present invention at different mass ratios of core to shell.

FIG. 3a) shows the characteristic of exemplary cathode active material according to the present invention with the mass ratio of core to shell of 99:1. The overlapping dots indicate two elements: nickel, which represents the NMC 811 material, and lanthanum, which represents LLZO. FIGS. (3b) and (3c) show the analysis of nickel and lanthanum of the cathode active material according to the present invention, respectively.

FIGS. (3d)-(3f) and (3g)-(3i) show the characteristics and the analysis of nickel and lanthanum of the cathode active material according to the present invention which are similar to FIGS. (3a)-(3c), except that the mass ratio of core to shell is 95:5 and 90:1, respectively.

According to such figures, it can be seen that upon increasing the ratio of the shell, which is LLZO, the amount of lanthanum increased on the surface of the active material. This confirms that lithium metal oxide compound which is an electrolyte is indeed present on the surface of the NMC 811 material.

FIG. 4 is images obtained from the transmission electron microscope (TEM) together with the analysis of elements and composition using the EDX technique showing the characteristic and the analysis of elements of the exemplary cathode active material according to the present invention. The mass ratio of core to shell is 99:1.

FIG. 4a) shows the characteristic of the cathode active material which is a spherical material with a particle size of 5-15 μm comprising the secondary particle of NMC 811. The NMC 811 material surface has a thin layer of LLZO which can be confirmed by FIG. 4b), which shows the analysis of elements of the active material. The overlapping dots indicate nickel which represents the NMC 811 material and lanthanum which represents LLZO. The test result according to FIG. 4 corresponds with the test result obtained from the study using the scanning electron microscope shown in FIG. 3.

### Study on the Structure of the Cathode Active Material

FIG. 5 is the graph obtained from the X-ray diffraction (XRD) analyzer showing the structures of the exemplary cathode active materials according to the present invention and the active material of the comparative cathode.

According to FIG. 5, it can be seen that the comparative active material (NMC 811) has an X-ray diffraction pattern with the R3m crystal structure consisting of planes 003, 101, 006/102, 104, 105, 107, 108/110 and 113 as indicated by the triangles as shown in FIG. 5. On the other hand, the cathode active material according to the present invention which has a low LLZO ratio has an X-ray diffraction pattern that is not different from that of the comparative active material, but upon increasing the amount of LLZO, X-ray diffraction pattern of LLZO is seen combined. However, this does not affect the previous diffraction pattern of the NMC 811 material. Therefore, it can be concluded that coating the NMC 811 material with LLZO does not change the main structure of the NMC 811.

### Study on the Button Battery's Charge-Discharge Profile

FIG. 6 is the graph showing the charge-discharge profiles of the button battery comprising the cathode according to the present invention having the active material at different ratios of NMC: LLZO and the comparative button battery.

The figure shows that the cathode having the LLZO-coated active material can improve the charge efficiency of the active material. The cathode having the active material, of which NMC core is coated with LLZO at the ratio of NMC:LLZO of 99:1, provides highest capacity compared to the button battery comprising the cathode according to the present invention at other ratios of NMC: LLZO and the comparative button battery.

### Study on the Stability and the Charge-Discharge Efficiency of the Button Battery

FIG. 7 is the graph showing the capacity retention at different cycle numbers of the button battery comprising the cathode according to the present invention which has the active material at different ratios of NMC: LLZO at 1 C current.

The test result shows that after 200 cycles, the capacity of the button battery with the ratio of LLZO of 1%, 5%, and 10% shows no significant difference. Thus, it can be concluded that coating the NMC core material with LLZO in an amount starting from 1% can significantly increase the stability and extend the cycle life of the battery.

### Study on the Rate Capability of the Button Battery

FIG. 8 is a graph showing the rate capability of button batteries comprising the cathode according to the present invention with the ratio of LLZO of 1%, and the comparative example cycled from 3.0 to 4.3 V at high current density.

The result shows that the normalized capacity from C/20 at high current densities from 3 C-10 C, the cathode having the active material, of which NMC core is coated with LLZO according to the present invention, exhibits good retention at 3 C and better performance at higher current density. Due to the LLZO coating may slow down Li mobility at the surface of NMC particles, the more utilized active material at high current density compared to the comparative example.

### Study on the Charge-Discharge Profile of the Cylindrical Battery

FIG. 9 shows the charge-discharge profiles of the cylindrical battery comprising the cathode according to the present invention and the comparative cylindrical battery.

According to the figure, it can be seen that both examples of battery provide the same capacity of approximately 2,300-2,500 mAh, suggesting that the cathode having the active material, of which NMC core is coated with LLZO according to the present invention, does not change the NMC structure. The battery still maintains a good charge efficiency as coating the active material with LLZO, which is a compound containing high lithium in its structure, helps to promote the ion exchange and increases the ion diffusion of lithium in the battery. Also, coating the NMC material surface can reduce the contact between the particles of the NMC material and the electrolyte solution which affects the long-term efficiency of the battery.

### Study on the Stability and the Charge-Discharge Efficiency of the Battery

FIG. 10 shows the capacity retention and the charge-discharge efficiency at different cycle numbers of the cylindrical battery comprising the cathode according to the present invention and the comparative battery.

FIG. (10a) shows the capacity retention and the charge-discharge efficiency of the battery comprising the cathode according to the present invention at 1 C current. The test result shows that after 120 cycles, the capacity only slightly decreased, indicating a good stability of the battery according to the present invention which results from the LLZO shell which helps to prevent the disintegration of the electrolyte solution in the battery, as well as reducing any unwanted side reaction between the cathode active material and the electrolyte solution. Furthermore, the battery comprising the cathode according to the present invention also demonstrates an extremely good charge-discharge efficiency at 100% over 120 cycles, indicating a good stability of the cathode active material according to the present invention.

FIG. (10b) shows the capacity retention and the charge-discharge efficiency of the battery comprising the comparative cathode at 1 C current. It was found that after 120 cycles, the capacity decreased noticeably.

FIG. 11 shows the capacity retention at different cycle numbers of the cylindrical battery comprising the cathode according to the present invention and the comparative battery which denotes the stability of both batteries. The graph shows that the battery using the cathode according to the present invention provides a higher stability at the capacity retention of approximately 80-100%. The capacity retention at the 120^{th} cycle is 88%, higher than the battery using the comparative cathode, whose capacity retention is approximately 60-80% with the capacity retention at the 120^{th} cycle of 74% only.

According to the test above, it can be seen that the cathode comprising the active material having the core-shell structure according to the present invention can help reduce the deterioration of the battery by 14%, as compared to the comparative battery that uses the NMC 811 electrode. In conclusion, the improvement of the cathode active material according to the present invention using LLZO as a shell for coating the NMC core provides a good capacity, increases the battery's stability by providing higher capacity retention, and extends the battery's cycle life, thus making it suitable for commercial and industrial applications.

### BEST MODE OF THE INVENTION

Best mode of the invention is as described in the detailed description of the invention.

1. A cathode active material for a lithium-ion battery having a structure comprising a core and a shell, wherein the core comprises lithium nickel manganese cobalt oxide compound, and the shell is lithium lanthanum zirconate (LLZO) with a mass ratio of core to shell in a range of 90-99 to 1-10.

2. The cathode active material according to claim 1, wherein the lithium nickel manganese cobalt oxide compound has a formula Li(NiaMnbCoc)O2, whereby 0<a<1, 0<b<1, 0<c<1 and the sum of a, b, and c is 1.

3. The cathode active material according to claim 2, wherein the lithium nickel manganese cobalt oxide compound has the formula Li(Ni0.8Mn0.1Co0.1)O2.

4. The cathode active material according to claim 1, wherein the lithium lanthanum zirconate has a particle size in a range of 5-15 μm.

5. The cathode active material according to claim 1, wherein the shell has a thickness in a range of 0.1-1,000 μm.

6. A method for preparing a cathode active material for a lithium-ion battery having a structure comprising a core and a shell, the method comprising the steps of:
(a) providing the core comprising lithium nickel manganese cobalt oxide compound having a shape and size as required,
(b) providing the shell which is lithium lanthanum zirconate, and
(c) coating the shell obtained from step (b) onto a surface of the core obtained from step (a) with a mass ratio of core to shell in a range of 90-99 to 1-10.

7. The method for preparing the cathode active material according to claim 6, wherein the lithium nickel manganese cobalt oxide compound has a formula Li(NiaMnbCoc)O2, whereby 0<a<1, 0<b<1, 0<c<1 and the sum of a, b, and c is 1.

8. The method for preparing the cathode active material according to claim 7, wherein the lithium nickel manganese cobalt oxide compound has the formula Li(Ni0.8Mn0.1Co0.1)O2.

9. The method for preparing the cathode active material according to claim 6, wherein lithium lanthanum zirconate has a particle size in a range of 5-15 μm.

10. The method for preparing the cathode active material according to claim 6, wherein the shell has a thickness in range of 0.1-1,000 μm.

11. The method for preparing the cathode active material according to claim 6, wherein step (c) is carried out using a mechanofusion process with a speed ranging from 2,500-5,000 rpm, motor power ranging from 0.5-1.5 kW, temperature ranging from 20-50° C., and period of time ranging from 10-60 minutes.

12. The method for preparing the cathode active material according to claim 6 further comprising step (d) of modifying the surface of the core formed to obtain a smooth surface prior to performing step (c).

13. The method for preparing the cathode active material according to claim 12, wherein step (d) is carried out using the mechanofusion process with a speed ranging from 1,500-3,500 rpm, motor power ranging from 0.2-1.2 kW, temperature ranging from 20-50° C., and period of time ranging from 10-30 minutes.

14. A cathode for a lithium-ion battery comprising:
the cathode active material according to claim 1,
a binder, and
a conductive material.

15. The cathode according to claim 14, wherein the binder is selected from polyvinylidene fluoride (PVDF), poly(3,4-ethylenedioxythiophene) (PEDOT), polytetrafluoroethylene (PTFE), and a mixture thereof.

16. The cathode according to claim 14, wherein the conductive material is selected from carbon black, acetylene black, super P, and a mixture thereof.

17. The cathode according to claim 14, wherein a weight ratio of cathode active material to binder to conductive material is in a range of 90-98 to 1-5 to 1-5.

18. A method for preparing a cathode for a lithium-ion battery comprising the steps of:
preparing a mixture of the cathode active material according to claim 1, binder, and conductive material, and
coating the obtained mixture onto a substrate.

19. The method for preparing the cathode according to claim 18, wherein the binder is selected from polyvinylidene fluoride, poly(3,4-ethylenedioxythiophene), polytetrafluoroethylene, and a mixture thereof.

20. The method for preparing the cathode according to claim 18 wherein the conductive material is selected from carbon black, acetylene black, super P, and a mixture thereof.

21. The method for preparing the cathode according to claim 18, wherein the substrate is aluminium.

22. The method for preparing the cathode according to claim 18, wherein the weight ratio of cathode active material to binder to conductive material is in a range of 90-98 to 1-5 to 1-5.

23. The method for preparing the cathode according to claim 18, wherein the preparation of the mixture of cathode active material, binder, and conductive material is carried out by a stirring using N-methylpyrrolidone solution as a solvent.

24. The method for preparing the cathode according to claim 18, wherein the obtained mixture of cathode active material, binder, and conductive material has a viscosity in a range of 4,000-10,000 Pa·s.

25. The method for preparing the cathode according to claim 18, wherein the mixture of cathode active material, binder, and conductive material is coated onto the substrate with a coating thickness of 200-270 μm.

26. The method for preparing the cathode according to claim 18 further comprising drying the coated substrate.

27. The method for preparing the cathode according to claim 26, wherein the substrate is dried by heating at a temperature ranging from 100-180° C.

28. A lithium-ion battery comprising the cathode according to claim 14.

29. The lithium-ion battery according to claim 28 which is a cylindrical battery.
